(19) United States
(12) Patent Application Publication
(10) Pub. No.: US 2025/0178659 A1
(43) Pub. Date: Jun. 5, 2025

(54) PADDLE SWITCH

(71) Applicant: Panasonic Automotive Systems Co., Ltd., Kanagawa (JP)

(72) Inventors: Daiki KABURAGI, Fukui (JP); Shota HIGASHIDANI, Kanagawa (JP); Toshio OSAWA, Kanagawa (JP); Mitsuo KODAMA, Fukui (JP)

(21) Appl. No.: 18/968,570

(22) Filed: Dec. 4, 2024

(30) Foreign Application Priority Data
Dec. 5, 2023 (JP) 2023-205692

(51) Int. Cl. B62D 1/04

(52) U.S. Cl. CPC B62D 1/046

(57) ABSTRACT

A paddle lever of a paddle switch includes: an operator that extends in an up-down direction of a vehicle; and a rotating shaft that extends in a direction that intersects an extending direction of the operator. The operator is rotatable about the rotating shaft. The operator includes: a first operating component that extends further in an upward direction of the vehicle than the rotating shaft; and a second operating component that extends further in a downward direction of the vehicle than the rotating shaft. The first operating component is rotatable about the rotating shaft to be closer to or farther away from the steering wheel than the rotating shaft is. The second operating component is rotatable about the rotating shaft to be closer to or farther away from the steering wheel than the rotating shaft is.

### CROSS REFERENCE TO RELATED APPLICATION

The present application is based on and claims priority of Japanese Patent Application No. 2023-205692 filed on Dec. 5, 2023.

### FIELD

The present disclosure relates to a paddle switch provided to a steering wheel of a vehicle.

### BACKGROUND

A paddle switch disclosed in Patent Literature (PTL) 1 includes: a case main body attached to a steering wheel; a switching mechanism that, when a paddle is rotated, is pressed and switches between coming in contact with or moving away from a contact point; a paddle rotatably supported by the case main body; and a clicking mechanism that imparts a clicking sensation when the paddle is rotated. The clicking mechanism is constituted from: a concave face provided inside the case main body; and a spring holder that houses a coil spring in an interior thereof and that is provided with a convex portion that is pressed to the concave face by the spring force of the coil spring.

### CITATION LIST

### Patent Literature

PTL 1: Japanese Unexamined Patent Application Publication No. 2013-086595

### SUMMARY

However, the paddle switch according to PTL 1 can be improved upon.

In view of this, the present disclosure provides a paddle switch capable of improving upon the above related art.

A paddle switch according to one aspect of the present disclosure includes: a paddle lever disposed further in a traveling direction of a vehicle than a steering wheel of the vehicle, in which the paddle lever includes: an operator that extends in an up-down direction of the vehicle; and a rotating shaft that extends in a direction that intersects an extending direction of the operator, the operator is rotatable about the rotating shaft, the operator includes: a first operating component that extends further in an upward direction of the vehicle than the rotating shaft; and a second operating component that extends further in a downward direction of the vehicle than the rotating shaft, the first operating component is rotatable about the rotating shaft to be closer to or farther away from the steering wheel than the rotating shaft is, and the second operating component is rotatable about the rotating shaft to be closer to or farther away from the steering wheel than the rotating shaft is.

The paddle switch according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates an example of a vehicle provided with a paddle switch according to an embodiment.

FIG. 2 is a perspective view illustrating the external appearance of the switching unit according to the embodiment.

FIG. 3A is an exploded perspective view illustrating the external appearance of the paddle switch according to the embodiment.

FIG. 3B is a plan view illustrating a steering wheel and the paddle switch.

FIG. 4 is a perspective view illustrating the external appearance of a returner according to the embodiment.

FIG. 5 is a cross-sectional view illustrating the paddle switch according to the embodiment.

FIG. 6 is an exploded perspective view illustrating the external appearance of an other paddle switch according to the embodiment.

FIG. 7 is a perspective view illustrating the external appearance of a returner of the other paddle switch according to the embodiment.

FIG. 8 is a cross-sectional view illustrating the other paddle switch according to the embodiment.

FIG. 9 is a perspective view illustrating the external appearance of an other returner according to the embodiment.

### DESCRIPTION OF EMBODIMENT

Hereinafter, the embodiment will be described in detail with reference to the drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the appended Claims and their equivalents. Therefore, among the elements in the following exemplary embodiment, those not recited in any one of the independent claims are described as optional elements.

Furthermore, each Drawing is a schematic illustration, and is not necessarily a strict representation. Moreover, in the Drawings, the same reference symbols are appended to the same elements.

Furthermore, in the following exemplary embodiment, expressions such as “plate-shaped”, “left-right direction”, “up-down direction”, and “traveling direction” are used. For example, “plate-shaped”, “left-right direction”, “up-down direction”, and “traveling direction” encompass not only the meaning of completely being a plate, left-right direction, up-down direction, and traveling direction, but also the meaning of substantially being a plate, left-right direction, up-down direction, and traveling direction, i.e., having a margin of error of about several %. Furthermore, “plate”, “left-right direction”, “up-down direction”, and “traveling direction” have the meaning of plate, left-right direction, up-down direction, and traveling direction to the extent that the effects of the present disclosure can be achieved. The same applies to cases of expressions in which other shapes and directions are used.

### Embodiment

### Configuration

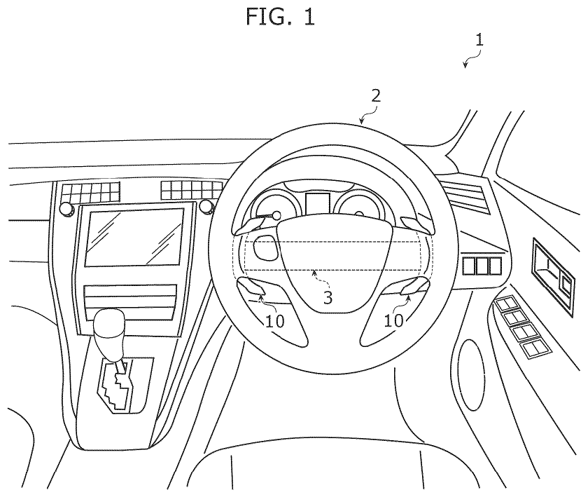

First, the configuration of paddle switch 10 will be described with reference to FIG. 1 to FIG. 9.

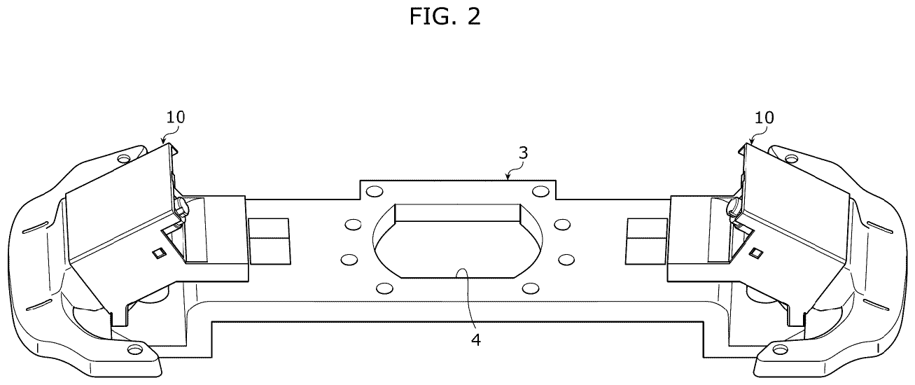

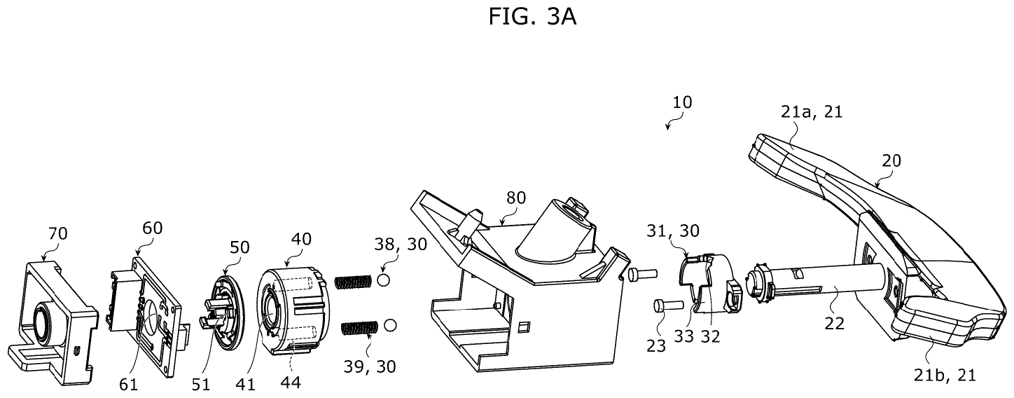

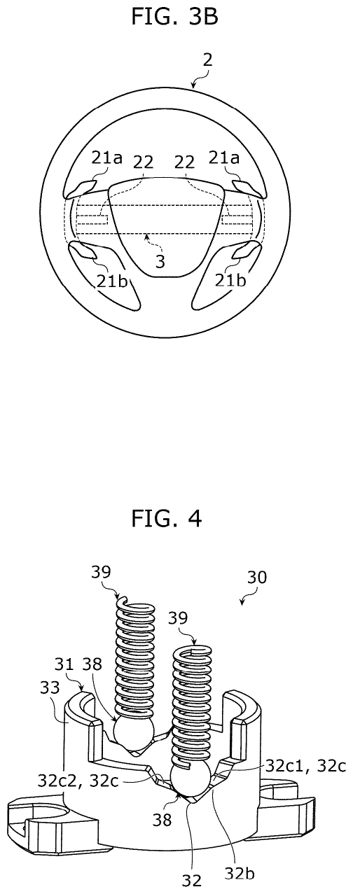

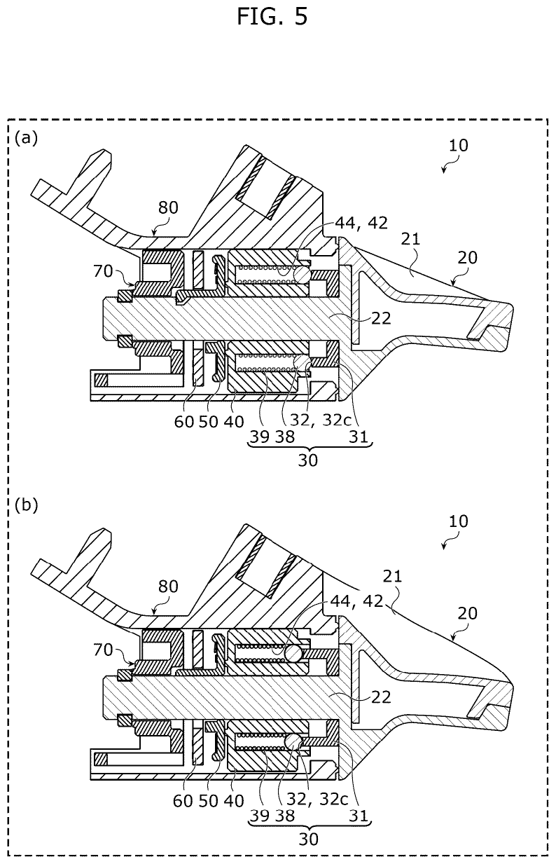

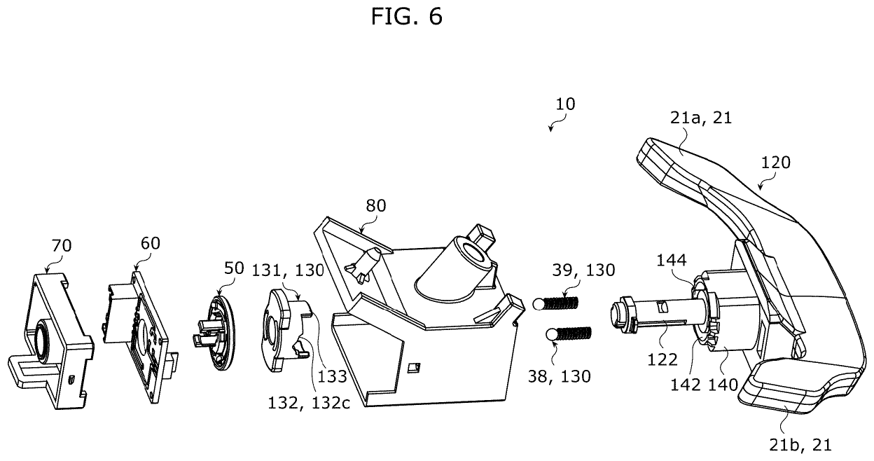

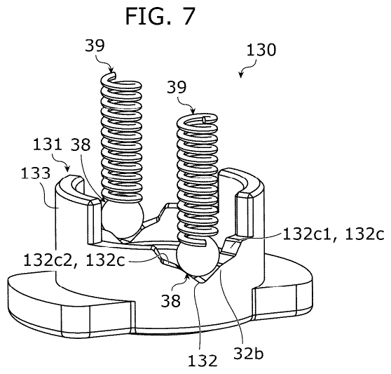

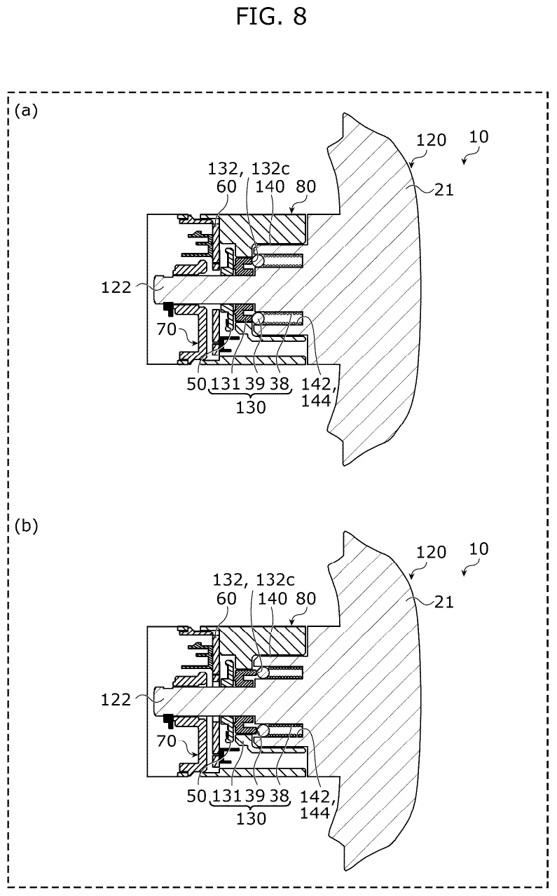

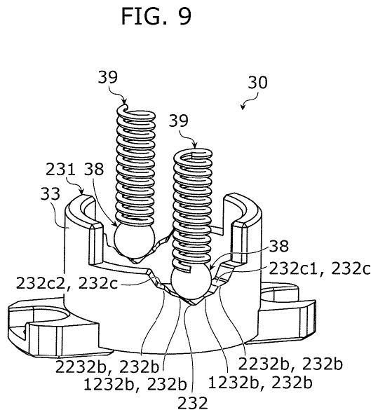

FIG. 1 illustrates an example of vehicle 1 provided with paddle switch 10 according to the embodiment. FIG. 2 is a perspective view illustrating the external appearance of a switching unit according to the embodiment. FIG. 3A is an exploded perspective view illustrating the external appearance of paddle switch 10 according to the embodiment. FIG. 3B is a plan view illustrating steering wheel 2 and paddle switch 10. FIG. 4 is a perspective view illustrating the external appearance of returner 30 according to the embodiment. FIG. 5 is a cross-sectional view illustrating paddle switch 10 according to the embodiment. In FIG. 5, (a) illustrates when operator 21 is in the home position. In FIG. 5, (b) illustrates when operator 21 is being operated by a driver. FIG. 6 is an exploded perspective view illustrating the external appearance of an other paddle switch 10 according to the embodiment. FIG. 7 is a perspective view illustrating the external appearance of returner 30 of the other paddle switch 10 according to the embodiment. FIG. 8 is a cross-sectional view illustrating the other paddle switch 10 according to the embodiment. In FIG. 8, (a) illustrates when operator 21 is in the home position. In FIG. 8, (b) illustrates when operator 21 is being operated by a driver. FIG. 9 is a perspective view illustrating the external appearance of an other returner 231 according to the embodiment.

As illustrated in FIG. 1, steering wheel 2 is provided to the vehicle interior of vehicle 1. A switching unit is provided further in the traveling direction of vehicle 1 than steering wheel 2. Further in the traveling direction of vehicle 1 than steering wheel 2 means the rear side of steering wheel 2 when steering wheel 2 is viewed from the perspective of the driver. Paddle switch 10 of the switching unit is disposed near steering wheel 2 on both the left and right sides of steering wheel 2 so as to be reached by the left and right finger(s) of the driver holding the steering wheel 2.

Paddle switch 10 is, for example, electrically connected to an ECU (Engine Control Unit). When paddle switch 10 is operated with finger(s) while the driver is holding steering wheel 2, paddle switch 10 outputs, to the ECU, a signal according to the operation. For example, paddle switch 10 can output: an ON signal for a direction indicator for vehicle 1 when turning left or turning right; an ON signal for headlight high beams or flashing; an ON signal for driving a wiper function; and/or the like.

Specifically, as illustrated in FIG. 1 and FIG. 2, the switching unit includes main body plate 3 and paddle switch 10.

Main body plate 3 is a member for attaching paddle switch 10 to a steering column. Main body plate 3 is provided with through-hole 4 through which a steering shaft is inserted. Main body plate 3 is fixed to the steering column with the steering shaft inserted through through-hole 4.

Main body plate 3 is a long, plate-shaped member that extends in a left-right direction with respect to the steering column. Through-hole 4 is provided to a central portion of main body plate 3, whereby main body plate 3 is disposed on the steering column so as to project from the left and right of the steering column. In other words, in a case in which steering wheel 2 is in a central position, main body plate 3 is disposed such that the lengthwise direction of main body plate 3 is parallel to the left-right direction of steering wheel 2. Thus, the left-side end of main body plate 3 is disposed to be near the left side of steering wheel 2, and the right-side end of main body plate 3 is disposed to be near the right side of steering wheel 2.

Paddle switch 10 is disposed on each of left and right sides of main body plate 3. In other words, a pair of paddle switches 10 is disposed such that one paddle switch 10 is at each of both ends of main body plate 3.

As illustrated in FIG. 3A, each of the pair of paddle switches 10 has paddle lever 20, returner 30, holder 40, rotating plate 50, circuit board 60, cover 70, and case 80.

Paddle lever 20 has rotating shaft 22 and operator 21.

Rotating shaft 22 extends along the left-right direction, and the axial direction thereof extends in a direction that intersects (a direction orthogonal to) the lengthwise direction (extending direction) of operator 21. As illustrated in FIG. 3B, rotating shaft 22 extends along the left-right direction of vehicle 1 in a front view of paddle switch 10. In the present embodiment, intersecting includes not only intersecting in the shape of a cross, but also intersecting in the shape of the letter T.

As illustrated in FIG. 3A, operator 21 is coupled to rotating shaft 22 so as to sandwich rotating shaft 22 from a direction orthogonal to the axial direction of rotating shaft 22, and operator 21 extends in the up-down direction of vehicle 1. Specifically, operator 21 is coupled to one end of rotating shaft 22 and, from the one end of rotating shaft 22, extends in the up-down direction orthogonal to the axial direction of rotating shaft 22. Operator 21 extends in the up-down direction of vehicle 1 in the front view of paddle switch 10. In the present embodiment, rotating shaft 22 is coupled to the central portion of operator 21. Thus, operator 21 is rotatable centered on rotating shaft 22, and rotating shaft 22 is rotatable integrally with operator 21.

Operator 21 is a plate-shaped lever that is operated by left finger(s) or right finger(s) of the driver. Operator 21 being operated causes the signal according to operator 21 to be outputted from circuit board 60.

Specifically, operator 21 has first operating component 21a and second operating component 21b. First operating component 21a of operator 21 is a component that is disposed at both ends of rotating shaft 22 and that extends further in the upward direction of vehicle 1 than rotating shaft 22, and second operating component 21b of operator 21 is a component that is disposed at both ends of rotating shaft 22 and extends further in the downward direction of vehicle 1 than rotating shaft 22.

First operating component 21a is rotatable about rotating shaft 22 to be closer to or farther away from steering wheel 2 than rotating shaft 22 is.

Second operating component 21b is rotatable about rotating shaft 22 to be closer to or farther away from steering wheel 2 than rotating shaft 22 is.

Since operator 21 rotates about rotating shaft 22, when first operating component 21a is rotated to be closer to steering wheel 2, second operating component 21b rotates to move farther away from steering wheel 2. Furthermore, when second operating component 21b is rotated to be closer to steering wheel 2, first operating component 21a rotates to move farther away from steering wheel 2.

A function of one of a direction indicator switch, a dimmer switch, or a wiper switch is assigned to: an operation of rotating first operating component 21a to be closer to or farther away from steering wheel 2 than rotating shaft 22 is; and an operation of rotating second operating component 21b to be closer to or farther away from steering wheel 2 than rotating shaft 22 is.

Since, in the present embodiment, the pair of paddle switches 10 are provided to main body plate 3, each signal is set to correspond to the two first operating components 21a and the two second operating components 21b.

For example, in paddle switch 10 on the left side, first operating component 21a corresponds to a wiper switch. When first operating component 21a is rotated to be closer to steering wheel 2 or when second operating component 21b is rotated to be farther away from steering wheel 2, an ON signal for a wiper function that involves automatic strong-and-weak rotation in accordance with rain conditions is outputted from circuit board 60. In paddle switch 10 on the left side, second operating component 21b corresponds to a dimmer switch. When first operating component 21a is rotated to be farther away from steering wheel 2 or when second operating component 21b is rotated to be closer to steering wheel 2, an ON signal for headlight high beams or flashing is outputted from circuit board 60.

In paddle switch 10 on the right side, first operating component 21a corresponds to a direction indicator switch for a left turn. When first operating component 21a is rotated to be closer to steering wheel 2 or when second operating component 21b is rotated to be farther away from steering wheel 2, an ON signal for a direction indicator for vehicle 1 when turning left is outputted from circuit board 60. In paddle switch 10 on the right side, second operating component 21b corresponds to a direction indicator switch for a right turn. When first operating component 21a is rotated to be farther away from steering wheel 2 or when second operating component 21b is rotated to be closer to steering wheel 2, an ON signal for a direction indicator for vehicle 1 when turning right is outputted from circuit board 60.

The pair of paddle switches 10 are thus equipped with a plurality of functions. Note that the above-described plurality of functions equipped to the pair of paddle switches 10 are merely examples, and are not limited to the present embodiment.

Operator 21 of the present embodiment employs an all-position momentary structure, being a self-returning structure in which operator 21 returns to the home position when the operation from the driver is canceled. This makes it possible to start from the home position during startup of vehicle 1.

As illustrated in FIG. 3A, FIG. 4, and (a) and (b) in FIG. 5, returner 30 is provided to rotating shaft 22. Returner 30 is a mechanism that returns operator 21 to the home position when operator 21 has been rotated to a position other than the home position. In the present embodiment, returner 30 includes click body 31, ball-shaped click pin 38, and click spring 39 that biases click pin 38 against click body 31.

Click body 31 is a member that is cylindrical in shape and coaxial with rotating shaft 22. Click body 31 is also referred to as a click plate. Rotating shaft 22, which extends along the axial direction of click body 31, is inserted through click body 31. Click body 31 is coupled and fixed to operator 21 using fixing member 23 such as a screw. Note that click body 31 may be coupled and fixed to operator 21 by means of an engagement component of click body 31 engaging with an engagement-receiving component of operator 21.

Since click body 31 is thus coupled and fixed to operator 21, click body 31 is rotatable integrally with rotating shaft 22 and operator 21.

Click body 31 may be integrally molded together with paddle lever 20. In other words, it can be stated that click body 31 is integrally molded together with rotating shaft 22. Being integrally molded together means that click body 31 and rotating shaft 22 cannot be separated without breakage. Note that click body 31 may be a separate body that is separable from paddle lever 20.

Click body 31 is provided with click notch 32, which is arranged in the rotating direction of operator 21. Click notch 32 is provided to click body 31 in the axial direction of rotating shaft 22. Click notch 32 is a notch provided to click body 31. In click body 31, two click notches 32 are provided, being aligned in a direction orthogonal to the axial direction. It can also be stated that identically shaped click notches 32 are provided in point symmetry, centered on the axial center of rotating shaft 22. Note that the total number of click notches 32 provided to click body 31 is not limited to two, and only one click notch 32 may be provided to click body 31. The case of one click notch 32 being provided to click body 31 can be applied, for example, in a case in which the force required for operating paddle lever 20 by the driver is small. Note that three or more click notches 32 may be provided to click body 31.

Click pin 38 is biased, in the axial direction of rotating shaft 22, against click notch 32 by click spring 39. Specifically, click pin 38 and click spring 39 are attached to holder 40 so as to press against click notch 32. Thus, while click pin 38 is being pressed against click notch 32 by click spring 39, click pin 38 and click spring 39 can be slid along click notch 32 together with the rotation of paddle lever 20.

Click notch 32 has inclined face 32c. Inclined face 32c is a general term that includes inclined face 32c1 on one side, and inclined face 32c2 on the other side. Inclined face 32c of click notch 32 is provided with at least one step portion 32b. Click pin 38 is located in a valley portion of click notch 32 when operator 21 is in the home position.

When first operating component 21a of operator 21 is operated, click pin 38 is slid along inclined face 32c1 on one side having step portion 32b and moves toward the back of housing 44, while click pin 38 is pushed against click notch 32 by click spring 39. At this time, click pin 38 moves past step portion 32b of inclined face 32c1 on the one side, whereby the load from click pin 38, which has moved past step portion 32b, is transmitted to operator 21 and becomes a load on operator 21, resulting in an operating sensation being obtained by the driver. Furthermore, when second operating component 21b of operator 21 is operated, click pin 38 is slid along inclined face 32c2 on the other side having step portion 32b and moves toward the back of housing 44, while click pin 38 is pushed against click notch 32 by click spring 39. At this time as well, click pin 38 moves past step portion 32b on inclined face 32c2 on the other side, whereby the load from click pin 38, which has moved past step portion 32b, is transmitted to operator 21 and becomes a load on operator 21, resulting in an operating sensation being obtained by the driver.

As illustrated in FIG. 3A, holder 40 is cylindrical in shape and coaxial with rotating shaft 22. Holder 40 is adjacent to click body 31 and is disposed at a position being on a side of click body 31 opposite the side near operator 21, such that holder 40 faces click notch 32 of click body 31. Holder 40 is provided with through-hole 41, through which rotating shaft 22 is inserted.

Holder 40 is coupled to case 80. The periphery of through-hole 41 of holder 40 is provided with concave engagement component 42 and housing 44.

When engagement-receiving component 33 of click body 31 is inserted into concave engagement component 42, holder 40 and click body 31 become connected. Since engagement-receiving component 33 of click body 31 is inserted into holder 40, click body 31 is rotatable, with respect to holder 40, together with the rotation of paddle lever 20.

Housing 44 houses click pin 38 and click spring 39 so as to expose click pin 38 and such that click pin 38 is movable along the inner face of housing 44.

Rotating plate 50 is adjacent to holder 40, and is disposed on a side of holder 40 opposite the side near click body 31. Rotating plate 50 is provided with through-hole 51, through which rotating shaft 22 is inserted. Since rotating plate 50 is coupled to rotating shaft 22, rotating plate 50 is rotatable integrally with rotating shaft 22.

Wiring having a movable contact is fixed to rotating plate 50. The wiring rotates in accordance with the rotation of rotating plate 50. Thus, in accordance with the rotation of rotating plate 50, the movable contact of the wiring electrically contacts and separates from the fixed contact of the wiring provided to circuit board 60. In other words, when rotating plate 50 rotates in conjunction with the rotation of operator 21, the wiring of rotating plate 50 also rotates. In this way, the movable contact of the wiring electrically contacts and separates from the fixed contact of circuit board 60, whereby the wiring of rotating plate 50 and the wiring of circuit board 60 thus open and close an electric circuit. This makes it possible for circuit board 60 to output the signal. In other words, circuit board 60 outputs a signal that corresponds to operator 21, which is being operated.

Circuit board 60 is adjacent to rotating plate 50, and is disposed on a side of rotating plate 50 opposite the side near holder 40. Circuit board 60 is provided with through-hole 61 through which rotating shaft 22 is inserted. Since circuit board 60 is not coupled to rotating shaft 22, circuit board 60 does not rotate integrally with rotating shaft 22.

Since circuit board 60 is coupled with, e.g., a lead wire for external connection, circuit board 60 is electrically connected to the ECU of vehicle 1. Thus, by executing a certain process in accordance with the signal from circuit board 60, the ECU is capable of, for example, flashing a lamp such as a turn signal lamp.

Case 80 houses rotating shaft 22 of operator 21, returner 30, holder 40, rotating plate 50, circuit board 60, and cover 70. Case 80 constitutes the outer shell of returner 30, holder 40, rotating plate 50, circuit board 60, and cover 70.

Cover 70 is adjacent to circuit board 60, and is disposed on a side of circuit board 60 opposite the side near rotating plate 50. Cover 70 covers circuit board 60 and protects circuit board 60. Cover 70 is coupled and fixed to case 80 so as to block an opening of case 80.

In such a pair of paddle switches 10, for example, when operator 21 is in the home position, click pin 38 is in a state of being pushed against the valley portion of click notch 32. When first operating component 21a of operator 21 rotates to be closer to steering wheel 2, click body 31 also rotates together with operator 21, and click pin 38 moves toward the back of housing 44 while sliding in a state of abutting inclined face 32c1 on one side of click notch 32 (the inclined face of the valley portion in click notch 32). When the operation on operator 21 by the driver is canceled, click pin 38 slides in the direction of returning to the valley portion of click notch 32 due to the biasing force of click spring 39, and in conjunction with this, returner 30 and first operating component 21a rotate in the direction of returning to the home position. Furthermore, when second operating component 21b of operator 21 rotates to be closer to steering wheel 2, click body 31 also rotates together with operator 21, and click pin 38 moves toward the back of housing 44 while sliding in a state of abutting inclined face 32c2 on the other side of click notch 32. When the operation on operator 21 by the driver is canceled, click pin 38 slides in the direction of returning to the valley portion of click notch 32 due to the biasing force of click spring 39, and in conjunction with this, returner 30 and second operating component 21b rotate in the direction of returning to the home position. In this way, as long as no operation is performed by the driver, operator 21 is always disposed in the home position.

Furthermore, in the above-described embodiment, the case in which click body 31 is coupled and fixed to operator 21 and rotating shaft 22 is inserted through holder 40 was described as an example, but for example, as illustrated in FIG. 6, FIG. 7, and (a) and (b) in FIG. 8, holder 140 may be integrally molded together with paddle lever 120. In other words, it can be stated that holder 140 is integrally molded together with rotating shaft 122.

In this case, concave engagement component 142 and housing 144 of holder 140 are open toward circuit board 60. Since engagement-receiving component 133 of click body 131 in returner 130 is inserted into concave engagement component 142 and click pin 38 and click spring 39 are housed in housing 144, holder 140, click pin 38, and click spring 39 are rotatable, with respect to click body 131, together with paddle lever 120.

Click body 131 is coupled to case 80 and fixed such that click body 131 cannot rotate. Click body 131 is disposed in case 80 such that click notch 132 faces concave engagement component 142 of holder 140.

There are more choices for the material of holder 140 than for click notch 132; thus, compared to the case of, e.g., FIG. 3A, in which rotating shaft 22 is inserted through holder 40, it is easier to integrally mold holder 140 together with paddle lever 120 to inhibit an increase in the total number of components in paddle switch 10.

In this case as well, when first operating component 21a of operator 21 rotates, holder 140 rotates, and click pin 38 enters a state of abutting inclined face 132c1 on one side of click notch 132. When the operation on operator 21 by the driver is canceled, click pin 38 moves in the direction of returning to the valley portion of click notch 132 due to the biasing force of click spring 39, and in conjunction with this, first operating component 21a and holder 140 rotate in the direction of returning to the home position. Furthermore, when second operating component 21b of operator 21 rotates, holder 140 rotates, and click pin 38 enters a state of abutting inclined face 132c2 on the other side of click notch 132. When the operation on operator 21 by the driver is canceled, click pin 38 moves in the direction of returning to the valley portion of click notch 132 due to the biasing force of click spring 39, and in conjunction with this, second operating component 21b and holder 140 rotate in the direction of returning to the home position. Note that inclined face 132c is a general term that includes inclined face 132c1 on one side, and inclined face 132c2 on the other side.

Furthermore, in the above-described embodiment, the case in which one step portion 32b was provided to each inclined face 32c of click notch 32 in the cylindrically shaped click body 31 was described as an example, but for example, a configuration such as that of click body 231 illustrated in FIG. 9 is also possible. A plurality of step portions 232b may be provided to each inclined face 232c of click notch 232 in click body 231.

In FIG. 9, first step portion 1232b and second step portion 2232b are provided to inclined face 232c of click notch 232. Note that step portion 232b is a general term that includes first step portion 1232b and second step portion 2232b.

For example, when first operating component 21a of operator 21 is operated, click pin 38 is slid along inclined face 232c1 on one side having step portion 232b and moves toward the back of housing 144 of FIG. 8, while click pin 38 is pushed against click notch 232 by click spring 39. At this time, click pin 38 moves past step portion 1232b of inclined face 232c1 on the one side, whereby the load from click pin 38, which has moved past first step portion 1232b, is transmitted to operator 21 and becomes a load on operator 21, resulting in an operating sensation being obtained by the driver. Furthermore, when first operating component 21a of operator 21 is operated, click pin 38 moves past step portion 2232b of inclined face 232c1 on the one side, whereby the load from click pin 38, which has moved past second step portion 2232b, is transmitted to operator 21 and becomes a load on operator 21, resulting in an operating sensation being obtained by the driver.

Furthermore, when second operating component 21b of operator 21 is operated, click pin 38 is slid along inclined face 232c2 on the other side having step portion 232b and moves toward the back of housing 44, while click pin 38 is pushed against click notch 232 by click spring 39. At this time as well, click pin 38 moves past first step portion 1232b of inclined face 232c2 on the other side, whereby the load from click pin 38, which has moved past first step portion 1232b, is transmitted to operator 21 and becomes a load on operator 21, resulting in an operating sensation being obtained by the driver. Furthermore, when second operating component 21b of operator 21 is operated, click pin 38 moves past step portion 2232b on the other side of inclined face 232c2, whereby the load from click pin 38, which has moved past second step portion 2232b, is transmitted to operator 21 and becomes a load on operator 21, resulting in an operating sensation being obtained by the driver.

Since click notch 232 is provided on the circumference of the cylindrically shaped click body 231, the length of click notch 232 can be secured while inhibiting an increase in size. Thus, various operating sensations can be obtained by the driver by, e.g., adopting the configuration in which a plurality of step portions 232b are provided to inclined face 232c of click notch 232 such that the driver obtains a multi-stepped operating sensation.

Furthermore, different signals may be outputted from circuit board 60 in each of the case in which click pin 38 has moved past first step portion 1232b, and the case in which click pin 38 has moved past second step portion 2232b.

For example, circuit board 60 may be caused to output an ON signal for headlight flashing in the case in which second operating component 21b has been rotated to be closer to steering wheel 2 and click pin 38 has moved past first step portion 1232b; and furthermore, circuit board 60 may be caused to output an ON signal for headlight high beams or flashing in the case in which second operating component 21b has been rotated to be move closer to steering wheel 2 and click pin 38 has moved past second step portion 2232b. This makes it possible to cause circuit board 60 to output a plurality of different signals by adopting a configuration in which a plurality of step portions 232b are provided to inclined face 232c of click notch 232 and second operating component 21b is rotated in a stepwise manner (the angle of rotation is changed).

Note that similarly, a configuration may be adopted in which first operating component 21a is rotated in a stepwise manner (the angle of rotation is changed), whereby different signals may be outputted from circuit board 60 in each of the case in which click pin 38 has moved past first step portion 1232b, and the case in which click pin 38 has moved past second step portion 2232b.

### Effects

Hereinafter, the effects of paddle switch 10 according to the present embodiment will be described.

Incidentally, in the paddle switch of PTL 1, only one switching mechanism is pressed during rotation of the paddle, resulting in the problem that the paddle switch cannot be applied in a case of making the switching mechanism correspond to a plurality of functions.

Consequently, as described above, paddle switch 10 of technique 1 in the present embodiment includes paddle lever 20, 120 disposed further in the traveling direction of vehicle 1 than steering wheel 2. Paddle lever 20, 120 has operator 21 that extends in the up-down direction of vehicle 1, and rotating shaft 22, 122 that extends in a direction that intersects the extending direction of operator 21. Operator 21 is rotatable about rotating shaft 22, 122. Operator 21 includes: first operating component 21a that extends further in the upward direction of vehicle 1 than rotating shaft 22, 122; and second operating component 21b that extends further in the downward direction of vehicle 1 than rotating shaft 22, 122. First operating component 21a is rotatable about rotating shaft 22, 122 to be closer to or farther away from steering wheel 2 than rotating shaft 22, 122 is. Second operating component 21b is rotatable about rotating shaft 22, 122 to be closer to or farther away from steering wheel 2 than rotating shaft 22, 122 is.

Accordingly, one paddle lever 20, 120 can be operated in two directions; thus, functions corresponding to first operating component 21a and second operating component 21b can be imparted to paddle lever 20, 120.

Therefore, the present disclosure makes it possible to achieve multifunctionality.

Furthermore, paddle switch 10 of technique 2 in the present embodiment is paddle switch 10 according to technique 1. In this case, paddle lever 20 includes: click body 31 that is cylindrical in shape and coaxial with rotating shaft 22; click spring 39; and click pin 38. Click notch 32 is provided to click body 31 in an axial direction of rotating shaft 22. Click spring 39 biases click pin 38 against click notch 32 in the axial direction of rotating shaft 22.

Accordingly, click notch 32 is provided to the cylindrically shaped click body 31; thus, movement length of click pin 38 can be increased. Therefore, click notch 32 can be freely designed such that an operating sensation is imparted when the driver operates paddle lever 20.

Furthermore, paddle switch 10 of technique 3 in the present embodiment is paddle switch 10 according to technique 2. In this case, click body 31 is integrally molded together with paddle lever 20.

This makes it possible to inhibit an increase in the total number of components in paddle switch 10.

Furthermore, paddle switch 10 of technique 4 in the present embodiment is paddle switch 10 according to technique 1. In this case, paddle switch 10 includes: holder 140 that is fixed to paddle lever 120, holder 140 being cylindrical in shape and coaxial with rotating shaft 122; and click body 131 that is connected to holder 140, click body 131 being cylindrical in shape and coaxial with rotating shaft 122. Click notch 132 is provided to click body 131 in an axial direction of rotating shaft 122. Click spring 39 biases click pin 38 against click notch 132 in the axial direction of rotating shaft 122.

Accordingly, the load is transmitted to operator 21 via click pin 38 and click spring 39, whereby the sensation of paddle lever 20 being operated can be imparted to the driver by freely setting the shape of click notch 132.

Furthermore, paddle switch 10 of technique 5 in the present embodiment is paddle switch 10 according to technique 4. In this case, holder 140 is integrally molded together with paddle lever 120.

Thus, there are more choices for the material of holder 140 than for click notch 132; thus, it is easy to provide holder 140 together with paddle lever 20 to inhibit an increase in the total number of components in paddle switch 10.

Furthermore, paddle switch 10 of technique 6 in the present embodiment is paddle switch 10 according to any one of techniques 1 to 5. In this case, one function among a direction indicator switch, a dimmer switch, and a wiper switch is assigned to each of: an operation of rotating first operating component 21a to be closer to or farther away from steering wheel 2 than rotating shaft 22, 122 is; and an operation of rotating second operating component 21b to be closer to or farther away from steering wheel 2 than rotating shaft 22, 122 is.

This makes it possible to use paddle switch 10 as a combination switch.

Furthermore, paddle switch 10 of technique 7 in the present embodiment is paddle switch 10 according to any one of techniques 2 to 6. In this case, at least one step portion 32b, 232b is provided to inclined face 32c, 32c1, 32c2, 132c, 132c1, 132c2, 232c1, 232c2 of click notch 32, 132, 232.

Accordingly, a load commensurate with the shape of inclined face 32c, 32c1, 32c2, 132c, 132c1, 132c2, 232c1, 232c2 of click notch 32, 132, 232 is transmitted to paddle lever 20, 120; thus, click notch 32, 132, 232 can be freely designed such that an operating sensation is imparted when the driver operates paddle lever 20, 120.

Furthermore, paddle switch 10 of technique 8 in the present embodiment is paddle switch 10 according to any one of techniques 1 to 7. In this case, a pair of paddle levers 20, 120 each being paddle lever 20, 120 are disposed further in the traveling direction of vehicle 1 than steering wheel 2 of vehicle 1.

Accordingly, paddle switches 10 can be disposed on the left and right of steering wheel 2, thereby enabling the further achievement of multifunctionality.

Furthermore, when a pair of paddle levers 20, 120 are disposed on the left and right of steering wheel 2, the driver can operate the pair of paddle levers 20, 120 with the left and right hands; thus, paddle switch 10 can be provided with favorable operability.

### Other Variations

Although the paddle switch according to the present disclosure has been described by way of the embodiment above, it should be obvious that the present disclosure is not limited to the embodiment described above. Various modifications conceived by a person of ordinary skill in the art may be performed on the embodiment in the scope of the present disclosure, unless such modifications depart from the essence of the present disclosure.

For example, in the above-described embodiment, the rotating shaft may be integrally molded together with the operator, or may be a separate body that is separable from the operator.

For example, the present embodiment is not limited to the case of attaching paddle switch 10 to the steering column; paddle switch 10 may be attached to the rear face of steering wheel 2. In this case, the up-down direction of vehicle 1, the left-right direction of vehicle 1, and the like refer to the up-down direction of vehicle 1, the left-right direction of vehicle 1, and the like with steering wheel 2 in the central position.

Note that the present disclosure also includes embodiments implemented through various modifications to the above-described embodiment conceived by a person of ordinary skill in the art, as well as embodiments realized by freely combining elements and functions in the embodiment within a scope not materially departing from the spirit of the present disclosure.

While the embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in its entirety: Japanese Patent Application No. 2023-205692 filed on Dec. 5, 2023.

### INDUSTRIAL APPLICABILITY

The paddle switch according to the present disclosure can be used as a man-machine interface in a vehicle.

1. A paddle switch comprising:
a paddle lever disposed further in a traveling direction of a vehicle than a steering wheel of the vehicle, wherein
the paddle lever includes:
an operator that extends in an up-down direction of the vehicle; and
a rotating shaft that extends in a direction that intersects an extending direction of the operator,
the operator is rotatable about the rotating shaft,
the operator includes:
a first operating component that extends further in an upward direction of the vehicle than the rotating shaft; and
a second operating component that extends further in a downward direction of the vehicle than the rotating shaft,
the first operating component is rotatable about the rotating shaft to be closer to or farther away from the steering wheel than the rotating shaft is, and
the second operating component is rotatable about the rotating shaft to be closer to or farther away from the steering wheel than the rotating shaft is.

2. The paddle switch according to claim 1, wherein
the paddle lever includes:
a click body that is cylindrical in shape and coaxial with the rotating shaft;
a click spring; and
a click pin, wherein
a click notch is provided to the click body in an axial direction of the rotating shaft, and
the click spring biases the click pin against the click notch in the axial direction of the rotating shaft.

3. The paddle switch according to claim 2, wherein
the click body is integrally molded together with the paddle lever.

4. The paddle switch according to claim 1, comprising:
a holder that is fixed to the paddle lever, the holder being cylindrical in shape and coaxial with the rotating shaft; and
a click body that is connected to the holder, the click body being cylindrical in shape and coaxial with the rotating shaft, wherein
a click notch is provided to the click body in an axial direction of the rotating shaft, and
a click spring biases a click pin against the click notch in the axial direction of the rotating shaft.

5. The paddle switch according to claim 4, wherein
the holder is integrally molded together with the paddle lever.

6. The paddle switch according to claim 1, wherein
one function among a direction indicator switch, a dimmer switch, and a wiper switch is assigned to each of: an operation of rotating the first operating component to be closer to or farther away from the steering wheel than the rotating shaft is; and an operation of rotating the second operating component to be closer to or farther away from the steering wheel than the rotating shaft is.

7. The paddle switch according to claim 2, wherein
at least one step portion is provided to an inclined face of the click notch.

8. The paddle switch according to claim 2, wherein
a pair of paddle levers each being the paddle lever are disposed further in the traveling direction of the vehicle than the steering wheel of the vehicle.
